(19) United States
(12) Patent Application Publication
(10) Pub. No.: US 2008/0093813 A1
(43) Pub. Date: Apr. 24, 2008

(54) TROLLEY

(75) Inventors: Peter James KEMP, Palmerston North (NZ); Ian McQueen, Palmerston North (NZ)

Correspondence Address: YOUNG & THOMPSON, 745 SOUTH 23RD STREET, 2ND FLOOR, ARLINGTON, VA, 22202, US

(73) Assignee: THE TOOL KIT TROLLEY LIMITED, PALMERSTON NORTH (NZ)

(21) Appl. No.: 11/772,897

(22) Filed: Jul. 3, 2007

(30) Foreign Application Priority Data
Jul. 3, 2006 (AU) 2006202808

(51) Int. Cl. B62B 3/00

(52) U.S. Cl. 280/47.35

(57) ABSTRACT

A trolley includes a frame which is constructed having storage elements and moving elements. The storage element is adapted to allow equipment to be stored therein and the moving element allows the trolley to be easily moved with or without any equipment stored thereon.

### FIELD OF THE INVENTION

This invention relates to a trolley. In particular, the invention relates particularly to but is not limited to a trolley for sports or recreational equipment.

### BACKGROUND OF THE INVENTION

Transporting or moving equipment around sports facilities such as indoor or outdoor fields, stadiums and arenas, is a common problem. These days there is a lot of equipment that is available and needs to be shifted or moved. Often the spaces are large meaning that it takes along time to move equipment.

The equipment can be heavy and awkward to move making it difficult to find people to assist. Another problem is finding all the equipment which is often stored in a haphazard way meaning that time is required to find and locate. Equipment is often stored in odd places or can be located in inaccessible spots or heights.

Keeping tabs on all equipment which can be very costly to replace, is an ongoing problem

It is an object of the present invention to provide an improved trolley which will at least go some way toward overcoming some of the disadvantages of the prior art, or which will at least provide the public with a useful choice.

### SUMMARY OF THE INVENTION

Accordingly in one aspect, the invention consists in a trolley for equipment including
a frame,
storage means being located within the frame, and
moving means attached to the frame to allow the trolley to be moved,
such that the storage means includes at least one holder to hold at least one item of equipment.

Preferably the frame includes holding means for rugby ball kicking tees, cricket balls, rugby balls, basketballs, short bats, cricket wicket bases, Frisbees, softballs, long bats soft tubes, drinks, rope/straps, hoops such that no equipment protrudes therefrom.

Preferably the holding means is adapted to hold for rugby ball kicking tees, cricket balls, rugby balls, basketballs, short bats, cricket wicket bases, Frisbees, softballs or baseballs, comprise an upper grill frame and lower support.

Preferably the holding means for soft tubes, long bats and drinks comprise at least one upright hollow plastics tube attached to the frame at the front end.

Preferably the moving means includes a set of wheels on a wheel frame.

Preferably the trolley includes a pulling/pushing means which comprises a handle and arm pivotably attached to the wheel frame.

### DRAWING DESCRIPTION

The invention consists of the foregoing and also envisages constructions of which the following gives examples only.

One presently preferred embodiment of the invention will now be described with reference to the accompanying drawings, wherein;

FIG. 1 is a series of photographic views of the trolley fully loaded

FIG. 2 is a further series of photographic views of the trolley in a loaded and unloaded configuration

FIG. 3 is a schematic partial perspective view of the loaded trolley

FIG. 4 is a side view of the trolley showing the hoop side

FIG. 5 is an end view of the trolley at the front end

FIG. 6 is an end view of the trolley at the rear end

FIG. 7 is a schematic perspective view of the rugby ball tee holder

FIG. 8 is a schematic perspective view of the rugby ball holder

FIG. 9 is a schematic perspective view of the basket ball holder

FIG. 10 is a schematic perspective view of the short bat holder

FIG. 11 is a schematic perspective view of the tennis ball and softball/baseball holders

FIG. 12 is a schematic view of the wicket base holder and Frisbee holder

FIG. 13 is a schematic view of the cricket ball holder

FIG. 14 is a schematic partial perspective view of the hoop holder

### DETAILED DESCRIPTION

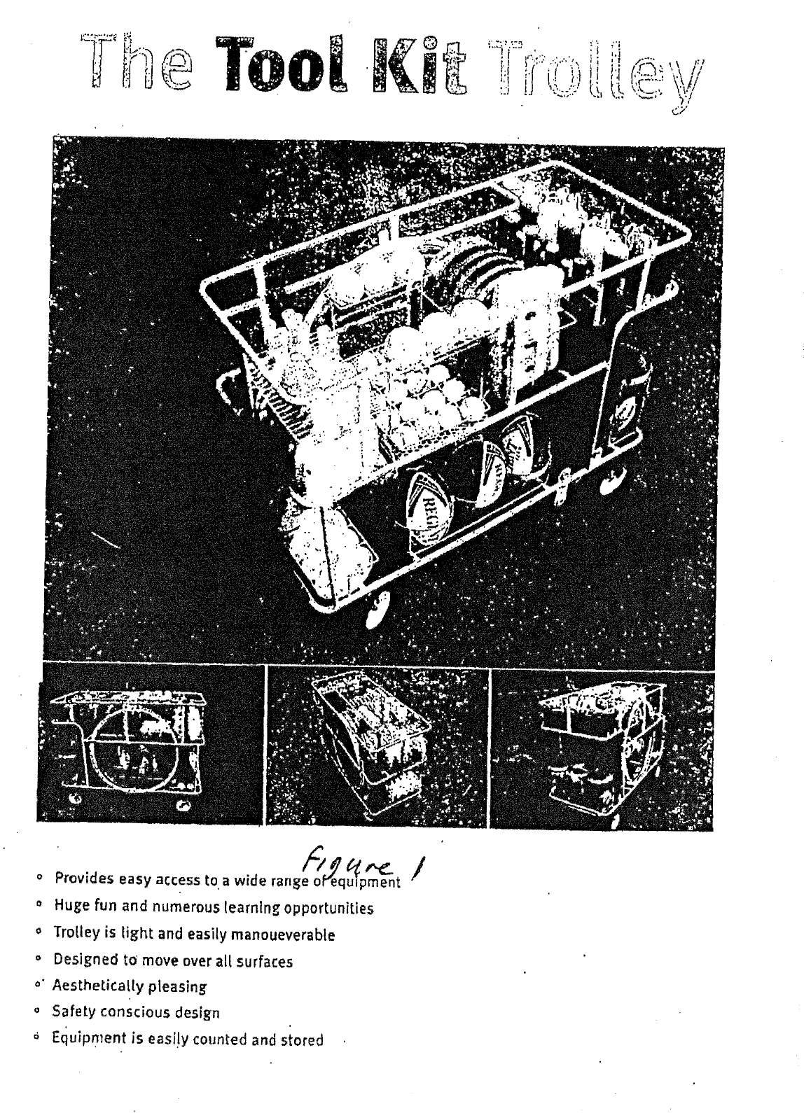

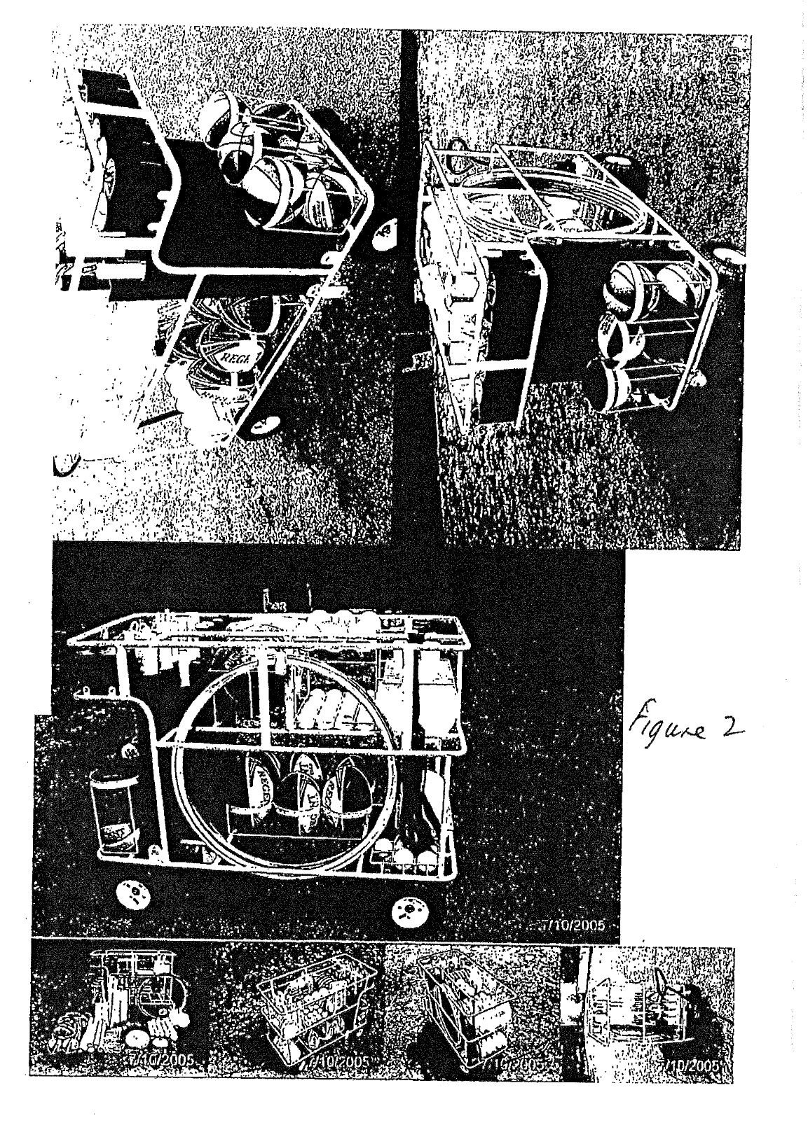

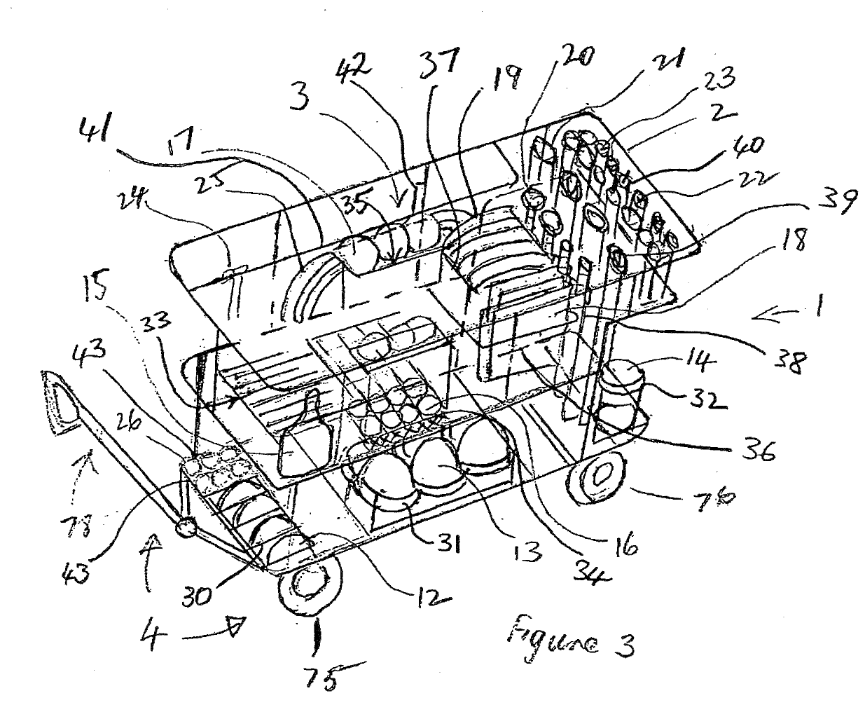

As shown in FIGS. 1-13 the trolley 1 is made up of a frame 2, storage means 3 and moving means 4. The trolley is adapted to carry any type of products such as sports equipment, recreational equipment, food or drinks. Storage means is made up of several different holders adapted and constructed to hold various items of equipment.

Frame 2 is constructed and shaped to provide sufficient strength to hold several objects, equipment or products and to be of a weight when loaded to be able to be moved as required. Frame 2 comprises a frame of tubular steel having a skeletal shape to suit the storage means 3. Frame 2 is generally made up of three layers or levels as labelled 5 (lowest), 6 (middle) and 7 (upper). In use there is an upper end 8, a lower end 9 adjacent the ground, rear end 10 and forward end 11.

Storage means 3 includes various shaped holders that allow for the storage and holding of various different items of equipment or products. In the drawings such examples of equipment are rugby balls kicking tees 12, rugby balls 13, basketballs 14, short bats 15, tennis balls 16, softballs or baseballs 17, cricket wicket bases 18, Frisbees 19, softball or baseball bats and cricket bats 20, soft polystyrene tubes 21, wickets or similar 22, drinks 23, straps 24, hoops 25 and cricket balls 26.

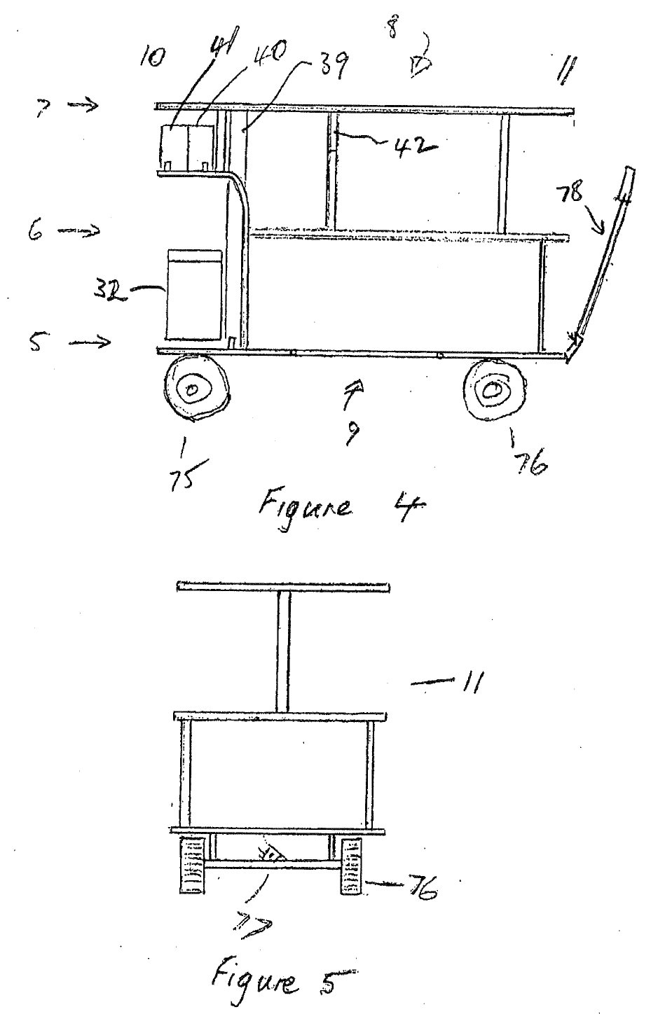

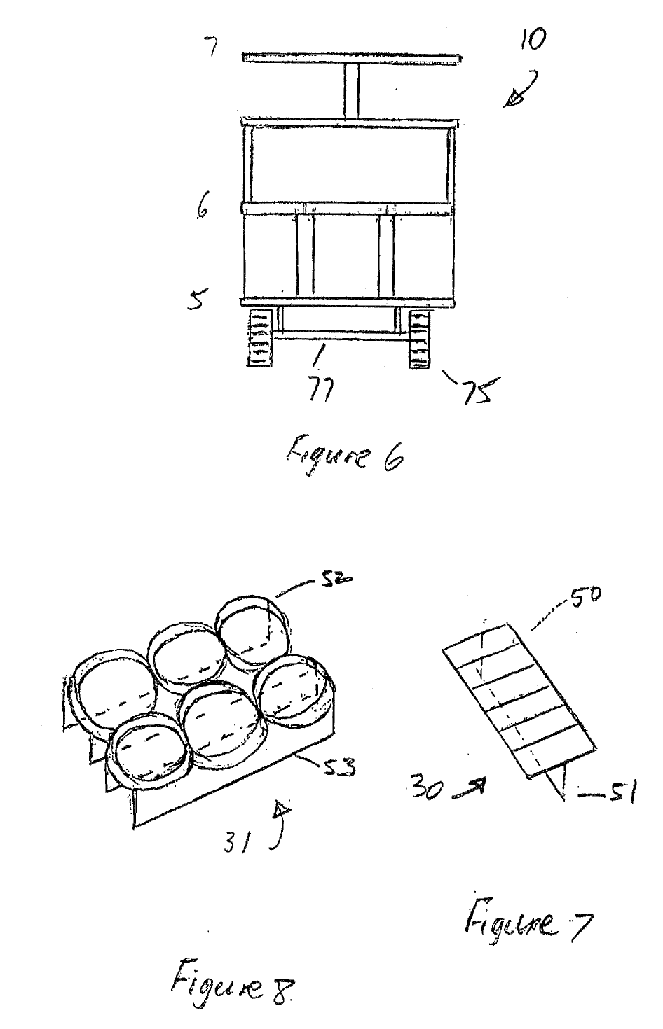

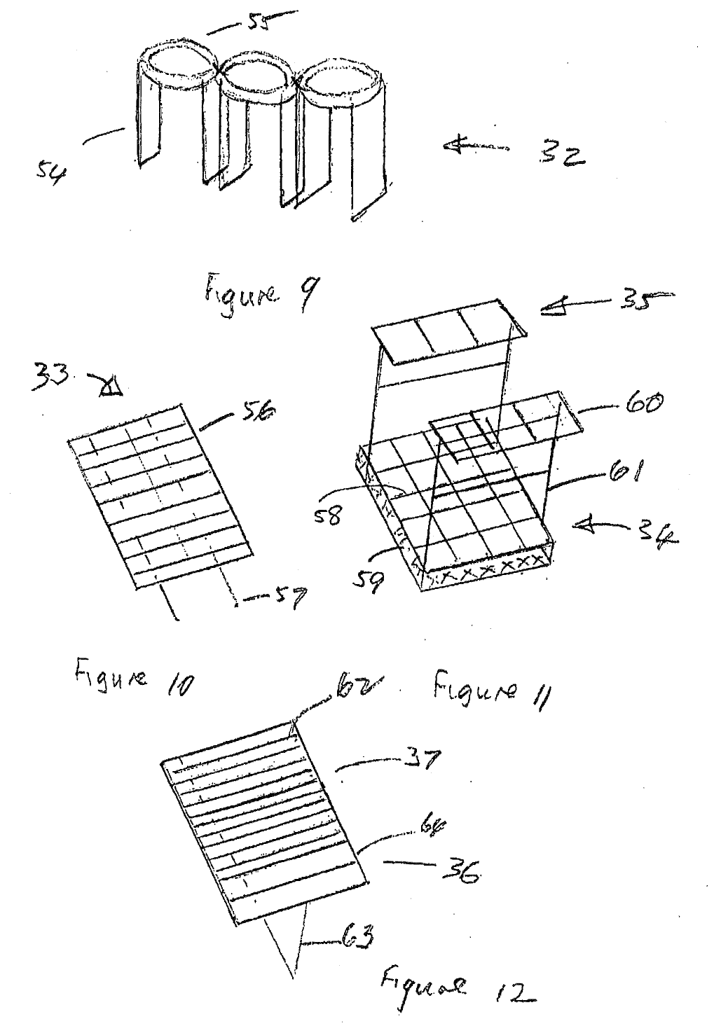

Storage means 3 for each of the above equipment include rugby ball tee holders 30 (see FIG. 7), rugby ball holders 31 (see FIG. 8), basketball holders 32 (see FIG. 9), short bat holders 33 (see FIG. 10), tennis ball holders 34 (see FIG. 11), softball/baseball holders 35 (see FIG. 11), and cricket wicket holders 36 (see FIG. 12), Frisbee holders 37 (see FIG. 12), long bat holders 38 (see FIGS. 1-3), soft tube holders 39 (see FIGS. 1-3), drink holders 40 (see FIGS. 1-3), strap holder 41 (see FIGS. 1-3), hoop holder 42 (see FIGS. 1-3) and cricket ball holder 43 (see FIGS. 1-3 & 13).

As shown in the drawings each holder 30-43 is shaped to suit the equipment being held and in general is made up of a framed structure that includes an upper portions, middle portions and lower portions. In some cases the frame 2 also provides support for the equipment being stored or held whereby each portion can be made up of a single frame or can be made up of unconnected portions which when fitted to the trolley frame form that holder frame. Each holder can be fixedly attached to the frame by non removing means (e.g. welding) or by removable means (e.g. bolting/screwing) if necessary. Tubular steel is shown for the frame and rod, grills and other alternative dimensions and material type(s) are equally possible as long as the equipment is able to be stored and held while the trolley is moving and/or stationary.

On the lowest level 5 of frame 2, at the front end 10, rugby tee holders 30 (FIGS. 4 and 7) are made up of a steel rod frame having in use upper open slots 50 and base rods 51, to hold each rugby ball tee in place. This is followed by rugby ball holders 31 (FIG. 8), which comprise oval or round hoops 52 at an upper end, made of strap steel held together in an outer rod frame 53. Basketball holders 32 as in FIG. 9 are located at the rear end 10 of frame 2 and comprise a steel rod upright frame 54 for several balls capped by steel strap upper frame portion 55.

Starting at the rear end 10 on middle level 6 short bat holders 33 as in FIGS. 1 & 10 are similar to rugby ball tee holders 30 in that they comprise an upper grill portion 56 and lower rods 57 which can connected via part of frame 2. Tennis ball holders 34 (FIG. 11) comprise an upper rod grill frame 58 and a lower mesh screen 59. Softball holders 35 can be attached or linked to tennis ball holder 34 and also have an upper grill type frame 60 connected to a lower support frame 61. Cricket wicket base holders 36 as in FIG. 12 also comprise an upper rod grill frame 62 and a lower wicket base support rod or tube 63. Frisbee holders 37 comprise an adjoining or co-terminus upper rod grill frame 64 and the lower rod or tube support 63. As shown Frisbee holder 37 is located beside wicket base holder 36 at the same position from the rear and front of frame 2.

Long bat holders 38, soft tube holders 39 and drinks holder 40 are located at the rear 10 end of the frame 2 and each comprise hollow upright tubes supported by rod or tube lower supports with an open upper end (and drainage at the lower end which can be substantially closed or have grilled base) to locate at least one such bat (cricket or softball etc). These black tubes can be screwed or bolted on place. In another option these tubes can be in the form of cages.

Frame 2 also has a strap holder 41 located at the upper level 7 which simply comprise a steel tube. Hoop holder 42 is also located at the upper level and comprises a hook shaped member cantilevered from within the frame 2 so that any hoops located thereon sit substantially within the trolley with the hoops also resting at their lower end on lower level 5.

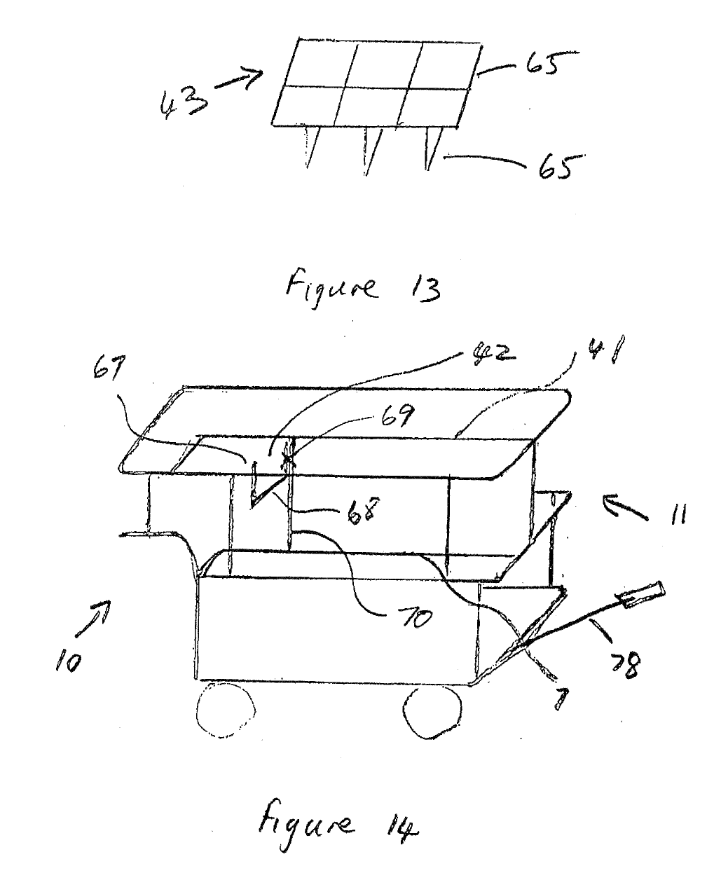

As shown in FIG. 13, trolley 1 also includes another holder 43 for balls such as cricket balls and is located on the lower level 5 beside the rugby ball tee holders 30. Cricket ball holder 43 comprises in use an upper grill frame 65 and a lower single base support rod 66.

As shown in FIG. 14 the hook shaped member 42 is upwardly hooked to allow at least one hoop to be held thereon. The hook shaped member has a distal upright end portion 67 joined to a horizontal portion 68 which in turn is supported by a supporting arm portion 69. The supporting arm portion 69 is attached to the frame 2 via a vertical internal frame member 70 which at its upper end is attached to frame member 41 and its lower end to horizontal bar 71 which is parallel in shape and orientation to holder bar 41. Overall hold 42 is U-shaped.

In use frame 2 sits on and is supported on the ground or any substrate by moving means 4. Moving means 4 includes a pair of wheels 75 & 76 located at each end of the trolley. The wheels can include a wheel frame 77 and steering means (not shown). Trolley 1 also includes a pulling/pushing means 78 which includes a handle pivotally attached to the wheel frame 77 or lower level 5 of the frame 2 thereby enabling in use at least one person to directly move the trolley manually or indirectly move the trolley via a motorized vehicle.

As shown in the figure frame 2 the middle level 6 is recessed at the rear end 10 to accommodate the basket balls 14 and basket ball holder 32. Middle level frame is raised towards the upper level.

The terms ‘short bats’ and ‘long bats’ are meant to describe any type of bat that fits such a description. For example ‘long bats’ are generally dimensioned as per baseball or softball bats which can be approximately 800 mm in length and ‘short bats’ can be approximately 350 mm in overall length. Other products can be adapted to be held (eg seats, food, refrigeration etc) and various optional features can include a sun/rain shade, storage cover, a lockable cover, motorization via electrical or fossil fuels or ride on facilities.

To those skilled in the art to which the invention relates, many changes in construction and widely differing embodiments and applications of the invention will suggest themselves without departing from the scope of the invention as defined in the appended claims. The disclosures and the description herein are purely illustrative and are not intended to be in any sense limiting.

The invention provides significant advantages over and above the prior art, and those skilled in the art will appreciate that a number of different latching mechanisms may be used to implement the invention.

Throughout the description and claims of this specification the word “comprise” and variations of that word, such as “comprises” and “comprising”, are not intended to exclude other additives, components, integers or steps.

The trolley can have some of the following advantages:
1. easy access to wide range of equipment
2. modest manufacturing cost
3. lightweight and easily manoeuvrable
4. all equipment held in a safe manner
5. equipment being held is easily stored and able to be counted
6. aesthetically pleasing modern design
7. saves time and energy

1. A trolley for equipment including
a frame,
storage means being located within the frame, and
moving means attached to the frame to allow the trolley to be moved,
such that the storage means includes at least one holder to hold at least one item of equipment.

2. A trolley as claimed in claim 1 wherein the frame includes holding means for rugby ball tees, cricket balls, rugby balls, basketballs, short bats, cricket wicket bases, Frisbees, softballs, long bats, soft tubes, drinks, rope/straps, hoops such that no equipment protrudes therefrom.

3. A trolley as claimed in claim 2 wherein the holding means is adapted to hold rugby ball kicking tees, cricket balls, rugby balls, basketballs, short bats, cricket wicket bases, Frisbees, softballs or baseballs, the holding means comprises an upper grill frame and lower support.

4. A trolley as claimed in claim 3 wherein the holding means for soft tubes, long bats and drinks comprise at least one upright hollow plastic tube attached to the frame at the front end.

5. A trolley as claimed in claim 1 wherein the moving mean includes a set of wheels movably supported by a wheel frame.

6. The trolley as claimed in claim 5 wherein the trolley includes a pulling/pushing means which comprises a handle and arm pivotably attached to the wheel frame.
